(19) United States
(12) Patent Application Publication
(10) Pub. No.: US 2004/0043147 A1
(43) Pub. Date: Mar. 4, 2004

(54) Color coated plastic pellets

(76) Inventor: Larry K Findley, Sandusky, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/451,098

(22) PCT Filed: Dec. 12, 2001
(86) PCT No.: PCT/US01/48723

(51) Int. Cl. B05D 7/00

(52) U.S. Cl. 427/212

(57) ABSTRACT

A process for preparing color coated plastic pellets comprises dispersing pigment in a carrier with a high-intensity mixer at a high shear rate in the absence of added heat energy for form plastic pigment particles, adding natural resin pellets to the plastic pigment particles within the high-intensity mixer, and mixing the plastic particles and natural resin pellets in the high-density mixer at a high shear rate in the absence of added heat energy to cause a coating of colored plastic to fuse to the surfaces of the natural resin pellets

### FIELD OF THE INVENTION

This invention relates generally to color coated plastic pellets, and more particularly to a process for applying a pigment-containing coating to plastic pellets and the color coated plastic pellets produced thereby.

### BACKGROUND OF THE INVENTION

A common method of coloring plastics is to use color concentrate pellets. A color concentrate pellet is solid and is typically comprised of pigment and carrier. The pigment colors the plastic. The carrier acts as a binder and generally also acts to “wet” the pigment so that the pigment will mix well with the resin or plastic to be colored and so that the pigment will be well dispersed throughout the final molded, extruded, cast, or otherwise formed plastic product.

In conventional color concentrate pellets, the pigment is mixed with a carrier, which is a thermoplastic resin material such as polypropylene, polyethylene, ABS, or polystyrene. These materials and the pellets produced thereby have a melting point in the range of 350° F. to 400° F. To make these conventional color concentrate pellets, the pigment and carrier are mixed and heated to about 550° F. to 600° F. The mixture melts and is mixed, and is extruded through an extruder and then solidifies and is cut into conventional pellet size, a cylinder about ⅛-inch in diameter and about ⅛ to ¼ inch in length.

These conventional color concentrate pellets contain organic and inorganic pigments, and are typically 30 percent to 50 percent pigment by weight with the balance being thermoplastic resin.

These conventional pellets are then mixed with natural resin pellets of the same general size and shape to effect colorization. Natural resin pellets are pellets which have not yet been colored. Commercially sized natural resin pellets include those that are cylindrically shaped, are about ⅛ inch in diameter, and are about ⅛ to ¼ inch long. Other commercially sized natural resin pellets, individually, have similar bulk or volume, but may have other regular geometric shapes or may have somewhat irregular shapes.

It is often the case, however, that a thermoplastic resin must be specially formulated or customized for a particular use or application, such as mold-in color processes, for example by including special additives for that use, such as pigments to achieve a particular color or a stabilizer package that meets the requirements of a particular use. In particular, thermoplastic resins may be customized to include certain pigments and/or colorants. It is often desirable that the manufactured articles have a particular color. A particular color may, for example, enhance aesthetic appeal of the article or may even serve to help identify the particular brand or manufacturer.

Customizing the color or additive package of thermoplastic resins can, however, present problems. While the general purpose thermoplastic resin, or base resin, may be produced by continuous extrusion operations, colored thermoplastic resins or thermoplastic resins with special additive packages are typically required in much smaller amounts that are relatively expensive to produce. Manufacture, especially post-production cleaning, is extremely labor intensive. The processing equipment (such as blenders, feeders, extruders, and pelletizing equipment) must be thoroughly cleaned after each particular color or customized blend in order to avoid contamination of the thermoplastic resins that will next be produced in the equipment. The cleaning process requires significant down time of the equipment during which no material is being manufactured, adding to the manufacturing costs of the specialized product.

Alternatively, colored articles have been produced by dry blending the uncolored thermoplastic resin with a color concentrate (also known as color masterbatch) in what is known in the art as a “salt and pepper blend.” The thermoplastic resin and the color concentrate used for such blends are typically of similar size pellets or pieces. The color concentrate is usually a minor amount by weight of the blend, typically only up to about 5 percent by weight, and often much less. The salt and pepper blend is then introduced directly to the molding or forming equipment used to produce the final article. The melt blending of the uncolored resin and the color concentrate must take place in the molding or forming equipment. This process, however, can result in color variations from piece to piece, or even in areas within the same piece, because of incomplete blending, particularly for low blending ratios of the color concentrate. Segregation of particular additives during packaging and transportation may also be experienced with dry blends and contribute to lack of homogeneity in the final formed articles.

It is also known to prepare color concentrates by a method of blending together a mixture of pigment, low molecular weight polyethylene wax, and thermoplastic polyolefin granules. The pigment and wax is included at relatively high levels, for example approximately 40 percent by weight of the mixture. The wax dispersed the pigment forms a layer on the polymer granules. This masterbatch is blended with unmodified base polyolefins to form a “salt and pepper” blend. The high loading of pigment and dispersing wax is required by the masterbatch in order to achieve the desired final pigment loading in the salt and pepper blend. Such masterbatch-containing blends suffer from the same problems discussed above. In addition, the relatively thick coating of wax on the granules is undesirable for the reason that such thick coatings tend to easily chip and flake off, which could result in segregation and nonhomogeneity in the molded articles, as well as dust problems in production.

A novel method of preparing customized thermoplastic resins in which the pieces, typically pellets, of thermoplastic resin are coated with a coating that comprises a polymeric component and an additive component has now been discovered. The polymeric component of the coating has a melting point, softening point, or glass transition temperature that is lower than the melting point, softening point, or glass transition temperature of the thermoplastic resin body.

In a preferred embodiment, the coating is a color concentrate comprising a polymeric component and one or more pigments, optionally with other additives. In a preferred embodiment, a substantially even thickness of an outer layer of the color coating is applied. The coated resin pieces or pellets are easy to handle and may be formed into articles using the same processes and in the same way as would resin pellets that have had the color or other additive integrally mixed in.

The color concentrate composition is coated onto the resin after the resin piece is formed. The customized thermoplastic resins of the invention may thus be produced in easy-to-clean equipment and without requiring down time of the equipment used to manufacture the thermoplastic resin body, resulting in a much more versatile and economical process. In addition, because each pellet or other body of the thermoplastic resin is in intimate contact with the pigment necessary to produce the desired customized resin, defects such as inhomogeneity, which are especially apparent when color is involved, are avoided. Further, the surfactants, water, amines, and resins with hydrophilic functionalities required by the prior art compositions are not necessary for the coatings of the present invention.

U.S. Pat. No. 5,846,607 discloses a process for customizing thermoplastic resins, by coating a thermoplastic resin body with a layer of a lower melting coating comprising a thermoplastic and a colorant. Wax, pigment, and natural resin pellets are processed at a temperature at which the coating is a melt, but at which the pellets remain solid. The coating may be applied to the natural resin pellets with the assistance of a high-intensity mixer. Thus, the process requires the addition of heat and is accomplished in a single mixing and coating process.

U.S. Pat. No. 5,455,288 discloses a process for producing a color concentrate pellet, also made by a single process step. These pellets, however, are color concentrate granules which must then be let down by blending with additional natural resin pellets.

U.S. Pat. No. 5,536,576 discloses natural resin pellets coated with a pigment. The pigment is dispersed in a liquid adhesive which is thereafter contacted with the natural resin pellets. Thus, the pellets bear a layer of colorant adhesively coated onto the surfaces of the pellets.

It would be desirable to prepare color coated plastic pellets by an energy-efficient process that would not substantially affect the inherent viscosity of the base pellets.

### SUMMARY OF THE INVENTION

A process for preparing color coated plastic pellets has surprisingly been discovered. The process comprises the steps of:

dispersing pigment in a carrier within a high-intensity mixer at a high shear rate in the absence of added heat energy, to form plastic pigment particles;

adding natural resin pellets to the plastic pigment particles within the high-intensity mixer; and

mixing the plastic pigment particles and natural resin pellets in the high-intensity mixer at a high shear rate in the absence of added heat energy, to cause a coating of colored plastic to fuse to the surfaces of the natural resin pellets.

The inventive process is particularly useful for preparing color coated plastic pellets from which a variety of plastic articles may be produced utilizing conventional plastic molding techniques.

### DETAILED DESCRIPTION OF THE PREFERRED EMBODIMENT

The present invention is directed to a process for preparing color coated plastic pellets, comprising the steps of dispersing pigment in a carrier within a high-intensity mixer at a high shear rate in the absence of added heart energy to form plastic pigment particles, adding natural resin pellets to the plastic pigment particles within the high-intensity mixer, and mixing the plastic pigment particles and the natural resin pellets in the high-intensity mixer at a high shear rate in the absence of added heat energy to cause a coating of colored plastic to fuse to the surfaces of the natural resin pellets.

The color coated plastic pellets of the invention have a thermoplastic resin body and an outer thermoplastic coating layer that at least partially covers the body. The coating includes a polymeric component that has an onset temperature for its melt processing range that is lower than the onset temperature of the melt processing range of the thermoplastic resin body. The coating also includes at least one colorant or pigment as the additive or as one of a plurality of additives.

The thermoplastic resin body is preferably a pellet. Thermoplastic resins are customarily manufactured as pellets for later processing into the desired article. The term “pellets” is understood and used herein to encompass various geometric forms, such as squares, trapezoids, cylinders, lenticular shapes, cylinders with diagonal faces, flakes, chunks, and substantially spherical shapes including a particle of powder or a larger-size sphere. While thermoplastic resins are often sold as pellets, the resin could be in any shape or size suitable for use in the equipment used to form the final article.

Typically, the thermoplastic resin body is a pellet which is cylindrical, approximately 3/32 to 5/32 inch in diameter, and preferably 4/32 inch (⅛ inch) in diameter. The length is typically about ⅛ to about ¼ inch, preferably ⅛ inch. The ⅛-inch length size feeds better at the end user.

The thermoplastic resin body may comprise virtually any thermoplastic resin suitable for forming into articles by thermal processes, molding, extrusion, or other such processes that may be employed in the methods of the invention, with the proviso that the thermoplastic resin of the resin body must have an onset temperature for its melt processing range higher than the onset temperature of the melt processing range of the polymeric component of the outer coating layer. For example, and without limitation, the following thermoplastic materials may advantageously be used: acrylonitrile-butadiene-styrene (ABS), acetal resins such as polyoxymethylene, acrylics, acrylonitrile (AN), allyl resins, cellulosics, epoxies, polyarylether ketones, polyether etherketones (PEEK), phenolics, polyamides (nylons), including polyamide-6, polyamide-6,6, polyamide-6,10, and so on; polyimides, polyamideimide resins, polyolefins (TPO, including polyethylene, polypropylene, and polybutylene homopolymers and copolymers; polycarbonates; polyesters, including polyalkylene terephthalates such as polybutylene terephthalate (PBT) and polyethylene terephthalate (PET); polyimides and polyetherimides; polyphenylene oxide; polyarylene sulfites such as polyphenylene sulfite; polyarylene sulfides such as polyphenylene sulfide; polyvinyl resins, including polystyrene (PS) and copolymers of styrene such as styrene-acrylonitrile copolymer (SAN) and acrylic-styrene-acrylonitrile copolymer (ASA), polyvinyl polymers including polyvinyl chloride (PVC) and polyvinylphenylene chloride; polyurethanes (TPU), and polysulfones, including polyarylether sulfones, polyether sulfones, and polyphenyl sulfones. Mixtures or block copolymers of two or more resins may also be used. Preferred materials for the thermoplastic resin body include polyesters, polyamides, polyolefins, polystyrenes and polystyrene copolymers, polyacetals, polycarbonates, acrylics, polyether etherketones, and mixtures of these. Polyesters, polyamides, polystyrenes and polystyrene copolymers, and mixtures of these are especially preferred.

The thermoplastic resin body is substantially encapsulated by the coating. By “substantially encapsulated” is meant that at least about three-quarters of the surface of the thermoplastic resin body is coated, and preferably at least about nine-tenths of the resin body is coated. It is particularly preferred for the coating to cover substantially all of the resin body. The coating of the customized thermoplastic resin has a thickness that will result in the desired weight ratio of coating composition to thermoplastic resin body composition when the two are formed into the final article. The weight ratio of coating to the thermoplastic resin may typically range at least about 0.1 percent by weight and up to about 10 percent by weight, based on the weight of the coated thermoplastic resin. Preferably, the coating is at least about 0.5 percent by weight and up to about 5 percent by weight, based on the weight of the coated thermoplastic resin. Thus, the coating thickness may depend upon such factors as the surface area of the thermoplastic resin body that is coated and the concentration of the additive or additives in the coating compared to the desired concentration in the final blend of the resin body and coating. For a typical cylindrical pellet, the coating may be up to an average of about 300 microns thick. In a preferred embodiment, the average thickness of the coating for such a pellet may be at least about 10 microns and up to about 200 microns.

The coating comprises a polymeric component and an additive component. The polymeric component comprises one or more resins or polymers. Examples of suitable materials for the polymeric component include, without limitation, the thermoplastic materials mentioned above as suitable for the resin body, waxes, and mixtures of these. In a preferred embodiment, the polymeric component is a crystalline material.

The additive component of the coating includes at least one colorant additive. Examples of additional suitable additives include, without limitation, plasticizers, thixotropes, optical brighteners, antioxidants, UV absorbers, hindered amine light stabilizers, hindered amide light stabilizers, heat stabilizers, flame retardants, conductive materials, nonfibrous reinforcements and particulate fillers such as talc, impact modifiers such as ionomers, maleated elastomers, and natural and synthetic rubber particles, processing aids such as lubricants, mold release agents, and slip agents, fragrances, antifoaming agents, antioxidants, antistatic agents, antimicrobials, biocides, and so forth.

The additive component of the coating comprises at least one pigment or colorant. Preferably, the pigment is present in an amount of up to about 8 percent by weight, and especially up to about 4 percent by weight, based on the weight of the customized thermoplastic resin. Suitable pigments are black, white, or color pigments, as well as extenders. Examples of useful pigments include, without limitation, titanium dioxide, zinc oxide, zinc sulfide, barium sulfate, aluminum silicate, calcium silicate, carbon black, black iron oxide, copper chromite black, yellow iron oxides, red iron oxides, brown iron oxides, ocher, sienna, umber, hematite, limonite, mixed iron oxides, chromium oxide, Prussian blue (ammonium ferrocyanide), chrome green, chrome yellow, manganese violet, cobalt phosphate, cobalt lithium phosphate, ultramarines, blue and green copper phthalocyanines, metallized and nonmetallized azo reds, gold, red, and purple quinacridones, mono-and diarylide yellows, naphthol reds, pyrrolo-pyrroles, anthraquinones, thioindigo, flavanthrone, and other vat pigments, benzimidazolone-based pigments, dioxazine, perylenes, carbazole violet, perinone, isoindoline, and so on.

In the present invention, it is normal to use combinations of organic and inorganic pigments. Typically, in such a case the organic pigment is used as a toner to give vivid color, while the inorganic pigment, which tends to be non-transparent provides a more opaque color and fills up the color so as to reduce transparency. Typically, high levels of inorganic pigments are used in combination with lower levels of organic pigments. If the loading level is 90 percent by weight, the pigment may be 100 percent inorganic. Alternatively, if a loading level of 90 percent pigment by weight is desired, up to about 40 percent organic pigment can be put in, with the balance being inorganic pigment. If a loading level of 70 percent pigment by weight is desired, up to about 40 percent organic pigment can be put in, with the balance being inorganic pigment. If a 60 percent loading level is desired, this could, for example, be achieved with 10 percent organic/50 percent inorganic, or 30 percent organic/30 percent inorganic, or 40 percent organic/20 percent inorganic.

The carrier is utilized to bind the pigment and also generally operates to wet the pigment so that it is more dispersible in the natural resin to be colored. Bis stearamide wax is a typical carrier. If dry powdered pigment is incorporated directly into natural resin, there is a tendency for it to form chunks and streaks, rather than to uniformly color the natural resin.

A carrier is not necessarily a single compound; combinations of ingredients can be utilized as a carrier, which may also be referred to as a “carrier system”. As utilized in the illustrated embodiments, the components of the carrier may have different melting points, but when mixed, the mixture or carrier will melt at about 160° F. to about 210° F. to about 220° F. The carrier has a melting point less than about 230° F., preferably at about or less than about 200° F. The color concentrate pellet, containing pigment and carrier, will melt at about the same temperature as that of the carrier of which it is formed. It is desirable that the carrier utilized be compatible with a wide range of types of natural resin. When this is achieved, a single type pellet can be utilized to color a variety of different types of natural resins. In the conventional art, as described above, a plurality of different types of pellets of the same color are, or may be, needed to color the same plurality of types of natural resin. The Examples hereinafter disclose carriers which are useful in the practice of the present invention.

To make pellets in accordance with the present invention, it is preferable to utilize a high intensity, bowl-type mixer, such as is known in the art and is available from the Henschel Company in Germany. This type mixer is jacketed and hooked up to a cooling system. It has a large rotary impeller that mixes and agitates the ingredients. The pigment and carrier, both in powdered form, are placed in the bowl without preheating. The mixer agitates and whips the ingredients by means of the impeller. This action frictionally raises the temperature of the ingredients. Heat is thus substantially mechanical rather than electrical or gas combustion in origin. As the melting point is approached, the carrier softens and agglomerates with the pigment particles. The pigment becomes wetted, ground, solvated, and encapsulated by the carrier. Encapsulation prevents the pigment from reagglomerating, and thus results in excellent pigment dispersion.

By “high intensity” mixer is meant a mixer that can apply about 10 horse power per cubic foot of material with high shear rate, with a maximum of 20,000 sec.sup.−1. Exemplary high intensity mixers include Banbury mixers, Prodex-Henschel mixers, and Welex-Papenmeier mixers. Such mixers typically have an impeller for mixing and applying energy to the batch, and a baffle for directing the motion of the product to the center of the vortex. Such mixers also have a jacket surrounding the mixing bowl so that cooling may be applied.

Generally, the mixer impeller is run at a tip speed of between about 2000 feet per minute (fpm) to about 4000 fpm, preferably between about 2500 fpm to about 3000 fpm. The degree of deflection of the mixer baffle may be adjusted from about 45° to about 0°, and preferably between about 15° to about 0°, where 0° refers to a radial orientation.

The particle surface will be heated to a temperature of at least about 10° C., preferably about 5° C., below the temperature at which the ingredients will soften and fuse. Persons skilled in the art recognize that mixing times will vary with the blending technique, apparatus and the choice of processing aid.

The particles will be mixed until their surface temperature is above that of the temperature required to soften the ingredients. Water may be passed through a water jacket to maintain control of the heating.

The high-intensity mixer is run until the power consumption drops to a level which indicates that the encapsulation process is complete. Granules, which are rounded, spherelike particles, are formed by this process. The granules are preferably about 10 microns to about 50 microns in diameter, and more preferably about 10 microns to about 30 microns in diameter. These granules can include up to about 90 percent pigment by weight. Processing the powdered pigment and carrier through the high intensity mixer can increase the bulk density of the mixture from about 1.75 times to about 3.5 times.

Thereafter, natural resin pellets are inserted into the high-intensity mixer, and the mixer is activated. This may occur while the color particles are still warm, or after the color particles have been allowed to cool. It is important to note that heat energy is at no time added to the ingredients nor the high-intensity mixer. Thus, the present process is highly energy efficient.

During this second process step, the color coating fuses to the surfaces of the natural resin pellets. Thereafter, the coated pellets may be cooled and removed from the high-intensity mixer for subsequent processing.

The coated pellets of the invention may be formed into articles according to any of the methods known in the art for thermal melt processing of thermoplastic resin compositions. For example, compression molding, vacuum molding, injection molding, thermoforming, blow molding, calendering, casting, extrusion, filament winding, laminating, rotational or slush molding, transfer molding, lay-up or contact molding, stamping, and combinations of these methods may be used with the customized thermoplastic resins formed by the present methods.

The color coated plastic pellets of the invention may be formed into any of the articles generally made with thermoplastic resins. Among the many possibilities are, without limitation, chair bases, electrical connectors and housing, automotive component including speaker grills, mirror housings, and fluid reservoirs, power tool housings, electrical appliance components such as refrigerator shelves and oven door handles, toys such as plastic building blocks, toothbrushes, and extruded films or layers.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A process for preparing color coated plastic pellets, comprising the steps of:
dispersing pigment in a carrier within a high-intensity mixer at a high shear rate in the absence of added heat energy, to form plastic pigment particles;
adding natural resin pellets to the plastic pigment particles within the high-intensity mixer; and
mixing the plastic pigment particles and natural resin pellets in the high-intensity mixer at a high shear rate in the absence of added heat energy, to cause a coating of colored plastic to fuse to the surfaces of the natural resin pellets.
